(19) United States
(12) Patent Application Publication
(10) Pub. No.: US 2014/0108065 A1
(43) Pub. Date: Apr. 17, 2014

(54) IMPROVEMENTS IN AND RELATING TO METHODS AND SYSTEMS FOR OPTIMISING CAPACITY USE IN AN OPERATION

(71) Applicant: Stanley Wootliff, Leeds (GB)

(72) Inventor: Stanley Wootliff, Leeds (GB)

(21) Appl. No.: 13/984,662

(22) PCT Filed: Feb. 13, 2012
(86) PCT No.: PCT/GB12/50314

§ 371 Date: Dec. 31, 2013

(30) Foreign Application Priority Data
Feb. 11, 2011 (GB) 1102487.4
Apr. 11, 2011 (GB) 1106122.3
May 6, 2011 (GB) 1107618.9
Aug. 5, 2011 (GB) 1113520.9
Aug. 22, 2011 (GB) 111443509

(51) Int. Cl. G06Q 30/02; G06Q 10/02; G06Q 50/12

(52) U.S. Cl. CPC G06Q 30/0202; G06Q 30/0207; G06Q 50/12; G06Q 10/02
USPC 705/5; 705/7.31

(57) ABSTRACT

A method for controlling an operation is provided wherein the control method increases demand relative to capacity when demand is normally low and/or increases the amount of time during which demand approaches or is at capacity so as to improve the productivity of the operation. The operation may be the cooking of food, for instance within a restaurant. The method of control includes the consideration of demand against capacity and as a result provides for variation in the incentive given to promote demand where needed. This may be the presence or absence of the incentive and/or the level of the incentive offered. The method may include the use of a booking system through which the incentives are offered and through which at least some of the indications of demand are received.

This invention concerns improvements in and relating to methods and systems for optimising capacity use in an operation, particularly in the context of providing and controlling reservation data, providing reservation systems, updating reservation systems and using reservation systems. The invention is particularly for use in operations in the food serving industry, such as in operations like restaurants.

On-line reservation systems are known, but these are often awkward to use in terms of the steps the customer user has to go through to make the reservation. They also offer little to the users, such as restaurant operators whose tables are booked via them, apart from the reservations themselves.

The terms a reservation and a booking, reserve and book, reserving and booking, reservation system and booking system are used interchangeably within this document.

In particular, the prior art does not offer occasion related incentives to customers using online reservation systems. The present invention provides time, day and date specific incentives to customers to encourage demand to suit the user.

The present invention has amongst its potential aims the provision of a dynamic and real time system for providing such incentives. The present invention has amongst its potential aims systems and/or method of providing and/or updating and/or using, which give benefits to the users and/or restaurant operators. The present invention has amongst its potential aims to influence the times, days and dates selected by users to the advantage of the user. The present invention has amongst its potential aims to influence the times, days and dates selected by users to the advantage of the restaurant owner. The present invention has amongst its aims to provide a capacity optimisation and booking control system.

According to a first aspect of the invention there is provided a booking system, the booking system comprising:

a computer and/or server and/or database;

a set of data, the set of data including one or more occasions for which a booking can be made, one or more of said occasions having associated with it an incentive, preferably the incentive being the change in price for one or more goods and/or services the customer will pay at that occasion compared with a defined price for the one or more goods and/or services;

one or more remote access routes through which one or more other computers and/or servers and/or databases can communicate with the computer and/or server and/or database.

The customer may be a diner.

The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

The occasion may be defined in terms of one or more parameters. The parameters may include one or more of time, day, date, month, year. The occasion may also be defined in terms of one or more further parameters. The one or more further parameters may include the number of customers for which the booking is to be made. A minimum number of customers for which the booking is to be made may be set, for instance 4 or more persons. Preferably the data set further includes one or more times for which a reservation can be made. Preferably the data set further includes one or more dates for which a reservation can be made and/or one or more days for which a reservation can be made.

The set of data may be stored on a computer and/or server and/or database.

The booking system may be accessed from one or more different electronic devices, such as computers, mobile telecommunication devices, tablets or the like, for instance via a telecommunications network, such as the Internet.

The system may further comprise a revised set of data. The revised set of data may include one or more changes compared with the set of data. One or more of the changes may be a variation in the incentive for a time compared with the incentive for that time in the set of data. The provision of the revised set of data may be triggered by the presence of the one or more bookings in the booking system.

According to a second aspect of the invention there is provided a method of making a booking, the method providing the steps of:

accessing a booking system;

viewing at least a part of a set of data held by the booking system, the set of data including one or more occasions for which a booking can be made, one or more of said occasions having associated with it an incentive, preferably the incentive being the change in price for one or more goods and/or services the user will pay at that occasion compared with a defined price for the one or more goods and/or services;

selecting an occasion from the one or more occasions for a booking.

The customer may be a diner.

The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

The method is preferably computer implemented.

The occasion may be defined in terms of one or more parameters. The parameters may include one or more of time, day, date, month, year. The occasion may also be defined in terms of one or more further parameters. The one or more further parameters may include the number of customers for which the booking is to be made. A minimum number of customers for which the booking is to be made may be set, for instance 4 or more persons. Preferably the data set further includes one or more times for which a reservation can be made. Preferably the data set further includes one or more dates for which a reservation can be made and/or one or more days for which a reservation can be made.

The set of data may be stored on a computer and/or server and/or database.

The booking system may be accessed from one or more different electronic devices, such as computers, mobile telecommunication devices, tablets or the like, for instance via a telecommunications network, such as the Internet.

The method may provide that selecting an occasion for a booking may cause the provision of a revised set of data. The revised set of data may include one or more changes compared with the set of data. One or more of the changes may be a variation in the incentive for a time compared with the incentive for that time in the set of data. The provision of the revised set of data may be triggered by the presence of the one or more bookings in the booking system.

According to a third aspect of the invention there is provided a method of configuring a booking system, the method providing the steps of:

providing a data structure;

inputting into the data structure a set of data, the set of data including one or more occasions for which a booking can be made, one or more of said occasions having associated with it an incentive, preferably the incentive being the change in price for one or more goods and/or services the customer will pay at that occasion compared with a defined price for the one or more goods and/or services.

The customer may be a diner.

The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

The method is preferably computer implemented. The occasion may be defined in terms of one or more parameters. The parameters may include one or more of time, day, date, month, year. The occasion may also be defined in terms of one or more further parameters.

The one or more further parameters may include the number of customers for which the booking is to be made. A minimum number of customers for which the booking is to be made may be set, for instance 4 or more persons. Preferably the data set further includes one or more times for which a reservation can be made. Preferably the data set further includes one or more dates for which a reservation can be made and/or one or more days for which a reservation can be made.

The set of data may be stored on a computer and/or server and/or database. The data structure may be provided by a service operator.

The set of data may be provided by a user, such as a restaurant operator.

The data may be inputted to the system from one or more different electronic devices, such as computers, mobile telecommunication devices, tablets or the like, for instance via a telecommunications network, such as the Internet.

According to a fourth aspect of the invention there is provided a method of controlling a booking system, the method providing the steps of:

providing a set of data, the set of data including one or more occasions for which a booking can be made, one or more of said occasions having associated with it an incentive, preferably the incentive being the change in price for one or more goods and/or services the customer will pay at that occasion compared with a defined price for the one or more goods and/or services;

inputting to the booking system one or more bookings;

providing a revised set of data, the revised set of data including one or more changes compared with the set of data, one or more of the changes being a variation in the incentive for a occasion compared with the incentive for that occasion in the set of data, the provision of the revised set of data being triggered by the presence of the one or more bookings in the booking system.

The customer may be a diner.

The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

The method is preferably computer implemented.

The occasion may be defined in terms of one or more parameters. The parameters may include one or more of time, day, date, month, year. The occasion may also be defined in terms of one or more further parameters. The one or more further parameters may include the number of customers for which the booking is to be made. A minimum number of customers for which the booking is to be made may be set, for instance 4 or more persons. Preferably the data set further includes one or more times for which a reservation can be made. Preferably the data set further includes one or more dates for which a reservation can be made and/or one or more days for which a reservation can be made.

The set of data may be stored on a computer and/or server and/or database.

The revised set of data may be stored on the same computer and/or server and/or database. The one or more bookings may be inputted to the system from one or more different electronic devices, such as computers, mobile telecommunication devices, tablets or the like, for instance via a telecommunications network, such as the Internet.

According to a fifth aspect of the invention there is provided a method for controlling an operation, the operation being provided by one or more processes, the method including:

providing one or more processors and/or process locations for performing the one or more processes, wherein the number of processors and/or process locations is limited in number, and wherein the one or more processors and/or process locations can perform one or more processes from a set of possible processes, and wherein each process in the set of possible processes takes a time period to perform, and wherein a capacity for the operation and/or processors and/or process locations is established;

providing a user interface through which one or more indications of demand for the method to operate one or more of the processors and/or process locations can be provided;

receiving one or more indications of demand for the method to operate one or more of the processors and/or process locations, the one or more indications of demand including timing information on an operation time when the method would be required to operate one or more of the processors, the one or more indications of demand being received in advance of the operation time;

considering the one or more indications of demand and associated timing information against the capacity for a given operation time in advance of that given operation time;

making one or more adjustments to the information accessible through the user interface, the one or more adjustments promoting one or more further indications of demand for the method to operate one or more of the processors and/or process locations to be made for one or more operation times where the one or more indications of demand are below a level, the level being defined relative to the capacity for those one or more operation times, the adjustment being made in advance of those one or more operation times;

receiving one or more further indications of demand for the method to operate one or more of the processors and/or process locations for an operation time where the one or more indications of demand are below the level for that operation time.

The customer may be a diner.

The user may be a restaurant operator.

The one or more adjustments may be the provision of or change to an incentive. The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

According to a sixth aspect of the invention there is provided a method for controlling an operation, the operation being provided by one or more processes, the method including:

providing one or more processors and/or process locations for performing the one or more processes, wherein the method or one or more parts thereof have a capacity;

providing a user interface through which one or more indications of demand for the method to operate one or more of the processors and/or process locations can be provided;

receiving one or more indications of demand for the method to operate one or more of the processors and/or process locations;

considering the one or more indications of demand;

making one or more adjustments to the information accessible through the user interface, the one or more adjustments promoting one or more further indications of demand for the method to operate one or more of the processors and/or process locations.

The customer may be a diner.

The user may be a restaurant operator.

The one or more adjustments may be the provision of or change to an incentive. The incentive may be a discount. The incentive may be a percentage discount. The incentive may be an occasion specific percentage discount. The incentive may be an occasion specific percentage discount, which is adjustable in real time The incentive may be a cash discount. The incentive may be a reward.

The method may provide that the number of processors and/or process locations is limited in number. The method may provide that the one or more processors and/or process locations can perform one or more processes from a set of possible processes. The method may provide that each process in the set of possible processes takes a time period to perform. The method may provide that a capacity for the operation and/or processors and/or process locations is established.

The method may provide that the one or more indications of demand include timing information on an operation time when the method would be required to operate one or more of the processors. The method may provide that the one or more indications of demand are received in advance of the operation time.

The method may further provide for considering the one or more indications of demand and associated timing information against the capacity for a given operation time in advance of that given operation time.

The method may provide for making one or more adjustments to the information accessible through the user interface. The method may provide that the one or more adjustments promote one or more further indications of demand for the method to operate one or more of the processors and/or process locations to be made for one or more operation times, for instance where the one or more indications of demand are below a level. The method may provide that the level is defined relative to the capacity for those one or more operation times. The method may provide that the adjustment being made in advance of those one or more operation times.

Preferably the method further provides the step of receiving one or more further indications of demand for the method to operate one or more of the processors and/or process locations for an operation time. Preferably these are for an operation time where the one or more indications of demand are below the level for that operation time.

The aspects of the invention may include any of the features, options or possibilities set out elsewhere in this application, including from amongst the following.

The customer may be a diner.

The user may be a restaurant operator.

The method may provide that one or more of the steps are computer implemented. For instance the establishment of the capacity for the operation and/or processors and/or process locations may be computer implemented and/or the providing a user interface may be computer implemented and/or the receiving one or more indications of demand may be computer implemented and/or the considering the one or more indications of demand and associated timing information against the capacity for a given operation time may be computer implemented and/or the making one or more adjustments to the information accessible through the user interface may be computer implemented and/or the receiving one or more further indications of demand for the method may be computer implemented.

The operation may be the operation of a catering operation, such as a restaurant, for instance a session, such as breakfast or lunch or diner, in the operation of a catering operation and in particular the start time for a meal and/or the pick up time for a take away meal.

The one or more processes may be occupation of a seat by a customer of the operation, such as a customer or a restaurant. The one or more processes may be the consumption of food and/or drink. The one or more processes may be a food generation process, such as one or more of the preparation of ingredients to cook and/or cooking and/or serving.

The one or more process locations may be defined by eating surface spaces and/or seating locations and/or floor space within the bounds of the operation, for instance the bounds of a restaurant. The one or more process locations may be defined by food generation spaces, for instance one or more of food preparation spaces, food cooking spaces, food serving spaces, food storage spaces. The one or more process locations may be defined by the vehicles delivering food and/or drink to the customer, for instance from a away restaurant.

The number of processors and/or process locations may be limited by the physical arrangement of the operation or a part thereof, such as the bounds of the operation's kitchen.

The set of processes may be the range of foods and/or drinks made available by the operation, for instance as defined by the menu for the operation.

The time period to perform a process may be a time or a time range. The time period may represent an established value, for instance an average, for that process. The time period may be the time period between a customer arriving at the operation and leaving the operation. The time period may be the time period between food preparation starting for a customer, for instance due to food being ordered, and food preparation ending for a customer, for instance due to the food being served and/or collected.

The capacity may be established be the number of processes which can be completed in a time unit. The capacity may be based upon the ratio of the time period to perform a process compared with the number of processors and/or process locations. The capacity may be a number per time unit.

The invention may include a customer interface.

The customer interface may be or be a part of a booking system, for instance a booking system as defined in the first and/or second and/or third and/or fourth aspects of the invention and/or elsewhere within this document. The customer interface may be an electronic device which include a computer, such as mobile telecommunication devices, tablets or the like, for instance a computer which accesses the booking system, for instance as defined in the first and/or second and/or third and/or fourth aspects of the invention and/or elsewhere within this document. Access may be through a telecommunications network, for instance as defined in the first and/or second and/or third and/or fourth aspects of the invention and/or elsewhere within this document.

The customer interface may enable the customer to make an indication of the number of customers for which a booking is being considered and/or is made. The number of customers may be required to be at or above a minimum number of customers for a booking to be possible, for instance 4 or more persons.

The customer interface may enable the customer to access a booking grid, for instance as defined in the first and/or second and/or third and/or fourth aspects of the invention and/or elsewhere within this document.

The customer interface may enable a customer to consider making an indication of demand, for instance through a booking. The customer interface may enable a customer to consider making an indication of demand at an operation time. The operation time may be defined in terms of date and/or day and/or time. The time may be a discrete time and/or be a time slot. The customer interface may enable a customer to consider the incentive offered for an operation time, preferably a plurality of operation times with potentially different incentives. The operator may set the incentive, for instance as defined in the first and/or second and/or third and/or fourth aspects of the invention and/or elsewhere within this document.

The customer may view the information accessible through the customer interface, particularly at least a part of a set of data, for instance held by the booking system.

The customer interface may enable a customer to make an indication of demand, for instance through a booking. The customer interface may enable a customer to make an indication of demand at an operation time. The operation time may be defined in terms of date and/or day and/or time. The time may be a discrete time and/or be a time slot.

The one or more indications of demand may be a reservation, for instance a reservation as defined in the first and/or second and/or third and/or fourth aspects of the invention and/or elsewhere within this document.

The one or more indications of demand may be received via a telecommunications network. Different customers may provide a plurality of indications of demand for the same and/or different operation times. The one or more indications of demand may be received by a booking system, for instance as defined in the first and/or second and/or third and/or fourth aspects of the invention and/or elsewhere within this document.

The timing information may be an occasion, for instance an occasion as defined in the first and/or second and/or third and/or fourth aspects of the invention and/or elsewhere within this document. The timing information, particularly as an occasion, may be defined in terms of one or more parameters, for instance one or more parameters as defined in the first and/or second and/or third and/or fourth aspects of the invention and/or elsewhere within this document.

The operation time may be an occasion, for instance an occasion as defined in the first and/or second and/or third and/or fourth aspects of the invention and/or elsewhere within this document. The operation time, particularly as an occasion, may be defined in terms of one or more parameters, for instance one or more parameters as defined in the first and/or second and/or third and/or fourth aspects of the invention and/or elsewhere within this document.

The one or more indications of demand may be received at least 30 minutes, preferably at least one hour, more preferably at least 4 hours and ideally at least 12 hours in advance of the operation time for that indication of demand.

The considering of the one or more indications of demand and associated timing information against the capacity for a given operation time may be made when the one or more indications of demand are received. This may be at least 30 minutes, preferably at least one hour, more preferably at least 4 hours and ideally at least 12 hours in advance of that given operation time.

The considering may be provided by a computer and/or server and/or database, for instance as defined in the first and/or second and/or third and/or fourth aspects of the invention and/or elsewhere within this document.

The considering and/or making of one or more adjustments may be provided in real time. The considering and/or making of one or more adjustments may be automatic upon one or more indications of demand being received.

The considering may lead to an adjustment. The considering may lead to no adjustment being made, for instance where the level is not reached and/or the capacity is not reached.

The making of the one or more adjustments may be an adjustment to an incentive, for instance an incentive as defined in the first and/or second and/or third and/or fourth aspects of the invention and/or elsewhere within this document. The adjustment may be made with respect to one or more operation times. The adjustment may be made to an operation time for which an indication of demand has been received, preferably the indication causing the consideration. The adjustment may be made to an operation time for which an indication of demand has not been received, preferably the indication causing the consideration was not received.

Any setting of an incentive, consideration of a change to an incentive, adjustment to an incentive or other change can be made in real time.

The adjustment may provide a revised set of data, for instance as defined in the first and/or second and/or third and/or fourth aspects of the invention and/or elsewhere within this document.

The information accessible through the customer interface may be or be a part of a set of data, for instance the set of data as defined in the first and/or second and/or third and/or fourth aspects of the invention and/or elsewhere within this document.

The one or more adjustments may promote a customer considering making an indication of demand after the adjustment to select a different operation time from their intended operation time and/or to consider making an indication of demand after the adjustment to an operation time for which the incentive is increased and/or prices are decreased. The one or more adjustments may promote a customer to make an indication of demand after the adjustment to select a different operation time from their intended operation time and/or to make an indication of demand after the adjustment to an operation time for which the incentive is increased and/or prices are decreased.

The operation times may be considered against a level. The operation times may be considered against a level specific to that day, date or time. The operation times may be considered against an individual level. The level may account for permanent factors which control capacity, such as operation size, and/or non-permanent factors which control capacity, such as staffing levels for the operation and/or equipment availability for the operation.

The adjustment to an operation time may be made at anytime in advance of the operation time. The adjustment may be made in respect of multiple operation times. The adjustment may be different for one or more operation times compared with one or more other operation times.

The one or more further indications of demand may be a reservation, for instance a reservation as defined in the first and/or second and/or third and/or fourth aspects of the invention and/or elsewhere within this document.

The one or more further indications of demand may be received via a telecommunications network. Different customers may provide a plurality of further indications of demand for the same and/or different operation times. The one or more further indications of demand may be received by a booking system, for instance as defined in the first and/or second and/or third and/or fourth aspects of the invention and/or elsewhere within this document.

The method may include a repeat of the considering step and/or making one or more adjustments step. The repeat may be triggered by an event. The event may be one or more further indications of demand being made and/or the passage of a period of time and/or reaching a time period left to the operation time. The method may include multiple repeats of the considering step and/or making one or more adjustments step, for instance in response to each event.

The method may include one or more of the one or more indications of demand and/or one or more of the one or more further indications of demand providing a demand.

The method may include operating one or more of the processors and/or process locations, preferably to answer one or more demands. The method may include the preparation of food and/or the cooking of food and/or the serving of food to answer one or more of the demands. The method may include a customer occupying one or more locations within the operation to answer one or more demands.

The method may include making one or more adjustments to change the distribution of the one or more indications of demand and/or the distribution of one or demands, for instance compared with the distribution before making the one or more adjustments.

The use of the method may provide a change in the distribution over time of the indications of demand, particularly compared with the distribution over time of indications of demand before the method is used and/or compared with the distribution over time of indications of demand if the method were not used.

The use of the method may provide for a greater number of operation times where the demand approaches the capacity.

The use of the method may provide a greater number of operation times where the one or more processors and/or process locations are in use.

The use of the method may promote demand during operation times where there is excess capacity compared with demand. The use of the method may increase the total number of processes performed by the operation over a duration of time.

The various aspects of the invention may include one or more of the following features, options or possibilities.

The user may set the incentive they offer as applying to different dates, days and times. The user may set the incentive they offer as applying according to the number of customers in the booking or potential booking. The user may vary over time the incentive they offer as applying to different dates, days and times. The user vary over time the incentive they offer as applying according to the number of customers in the booking or potential booking. The user may set the incentive they offer as applying to different dates and/or days and/or times according to the number of bookings received for those times and/or days and/or dates. This may be based upon previously observed numbers of bookings for those times and/or days and/or dates or for other times and/or days and/or dates deemed representative thereof. The user may set the incentive they offer as applying according to the number of customers in the booking or potential booking according to the number of bookings received. The user may vary the incentive they offer as applying to different dates and/or days and/or times according to the number of bookings received for those times and/or days and/or dates up to that point in time and/or up to a cut off point in time before that point in time. The user may set the incentive they offer as applying according to the number of customers in the booking or potential booking according to the number of bookings received up to that point in time and/or up to a cut off point in time before that point in time. Any setting of an incentive, consideration of a change to an incentive, change to an incentive or other change can be made in real time.

The number of customers in a booking or potential booking may determine whether there is any availability for that group in the restaurant and/or whether there is any availability for that group at that time and/or whether there is any incentive available to that group in the restaurant and/or whether there is any incentive available to that group at that time and/or what the level and/or form of incentive is which is available to that group in that restaurant and/or what the level and/or form of incentive is which is available to that group at that time.

The number of customers in a booking or potential booking may determine whether the method or system can be used to make a booking. For instance, the operator may decide for one or more or all times, days and dates that a minimum number of customers is required to make a booking. The minimum number of customers may be 4 or more persons.

The user may set a limit for the number of customers which can make bookings according to the incentive method. Customers who make a booking not according to the incentive method may not count towards that number. Customers who make a telephone booking and/or booking in person and/or booking via the restaurant's own online booking system may not count towards that number. The limit for the number of customers may be set with respect to one or more different dates and/or days and/or times. The limit for the number of customers may be set with respect to one or more or all of the booking grids and/or columns and/or rows and/or slots. The limit for the number of customers may be different between two or more different dates and/or days and/or times.

The customer may select a booking based upon a balance of the choice between their preferred time and/or date and/or day and/or number of customers against the level of incentive offered compared with that offered for one or more different times and/or dates and/or days and/or numbers of customers.

The system may include one or more computers and/or servers and/or one or more pieces of computer software and/or one or more telecommunications links there between. These may be the service operators and/or the users and/or the customers and/or one or more third parties. The system may include a service operator's website. The service operator's website may include an application section and/or a booking section and/or a configuration section. One or more of the sections may be provided on different computers and/or servers. The system may include one or more user's, such as restaurant operator's, websites.

The application section may provide means for a user, such as a restaurant operator, to apply to be a member. The application section may be provided on one or more servers of the system operator.

The application section may include one or more of: testimonials from users, such as member restaurant operators about the system; a demonstration of the interaction of a customer with the system; a demonstration of a user's interaction with the system; an application form for membership and a summary of the terms and conditions of operation of the membership and/or system. The application form may be an online application form. The data for the application form may be entered through a computer interface. The data may include one or more of: user's name, such as restaurant name; contact details; location(s); user, such as restaurant operator.

The application section may provide a member user, such as a member restaurant operator, with means to access one or more other sections of the system. The means of access may be or include a customer name and/or password and/or pin number.

The member user, such as the member restaurant operator, may access one or more sections of the system, for instance to review the terms and conditions of membership of the system and/or to confirm their acceptance of the membership agreement and/or terms and conditions.

The member user, such as member restaurant operator, may be provided with access to one or more pieces of information and/or computer software, for instance by download. The one or more pieces of information and/or computer software may enable the member user, such as member restaurant operator, to provide an electronic link, for instance via the Internet, between their website and the system, particularly a website in the system. The one or more pieces of information and/or computer software may define the shape and/or appearance and/or operation of the electronic link, for instance as a button a customer can click on using a customer interface, such as a mouse. The electronic link is available to customers of the website.

The member user, such as a member restaurant operator may be provided with access to a configuration section of the system. The configuration section may allow the member users, such as member restaurant operator, to set values for and/or change values for one or more or all of their data.

The member user, such as member restaurant operator, may be provided with access to training materials, demonstrations on the use of the configuration section for the system.

The configuration section may provide the member user, such as member restaurant operator, with the ability to access and configure their data which is considered by the customer when making a booking. The data may be presented in a booking grid. The booking grid preferably has a consistent appearance between different member users, such as member restaurant operators. The data enterable and/or editable by a different member user, such as member restaurant operator may include the incentive level for a time and/or day and/or date and/or whether there is availability for a time and/or day and/or date and/or number of customers. The data enterable and/or editable by a different member user, such as member restaurant operator, may include the ability to define the data with respect to one or more of: an eating session, such as breakfast or lunch or diner; a particular event, which may extend over more than one time slot, session or day, such as Christmas party dining; a particular group of food and/or drink options, such as a set menu. The data enterable and/or editable may be provided in one or more menus, for instance a pull down menu and/or a menu associated with a date and/or day and/or time. The menu may feature one or more pre-set forms of incentive, for instance a series of percentage discounts as the incentive. The data may be provided in one or more slots in the booking grid. The booking grid may feature a row or column for each day in a time period. The time period may be a week. Other booking grids for other time periods may be included in the booking section. The booking grid may include a column or row for each different time slot in a further time period. The further time period may a day or a part of a day. The part of a day may be between opening and closing for the operation, such as a restaurant. The part of the day may be the morning and/or lunchtime and/or afternoon and/or evening of a day.

The different member user, such as member restaurant operator may access the configuration section of the system at a first time and enter data for the booking section and/or one or more booking grids and/or one or more templates or reference sources, for instance used to populate one or more booking grids. One or more or all of the slots in a booking grid may be so entered with data. The different member user, such as member restaurant operator may access the configuration section of the system at one or more further times and amend data and/or enter new data for the booking section and/or one or more booking grids and/or one or more templates or reference sources, for instance used to populate one or more booking grids. One or more or all of the slots in a booking grid may be so entered with data at the one or more further times.

The system and/or one or more pieces of software provided by the system may access the configuration section of the system at a first time and enter data for the booking section and/or one or more booking grids and/or one or more templates or reference sources, for instance used to populate one or more booking grids. One or more or all of the slots in a booking grid may be so entered with data. The system and/or software provided by the system may access via the configuration section and/or via another route. The system may provide for the data to be amended periodically or continuously. The amendments made may respond to the time and/or date and/or day and/or incentive for one or more bookings made using the system and/or made other than through the system but notified to the system.

The configuration section and/or a review section may provide a display of the performance of the system. The display may provide for the total number of bookings for one or more times and/or days and/or dates and/or years, including values for individual times and/or days and/or dates and/or years or groups thereof. The display may provide for the number of bookings made using the method and/or made through a booking grid for one or more times and/or days and/or dates and/or years, including values for individual times and/or days and/or dates and/or years or groups thereof. The display may be used by the user to decide one or more alterations to one or more incentives.

The booking grid and/or data therein and/or rows and/or columns and/or slots may be entered with data and/or amended data to allow the member user, such as member restaurant operator to achieve one or more functions. The one or more functions may include optimising or maximising capacity utilisation in the restaurant and/or kitchen of the restaurant; optimising or maximising use of the seating capacity of the restaurant and/or the kitchen capacity of the restaurant.

The booking grid may be provided with data which states the incentive a customer can have on goods and/or services provided by the restaurant if they book a time and/or date and/or day.

The incentive may be a function of the number of customers indicated for the occasion. The incentive may be expressed as a monetary value. The incentive may be expressed as a percentage incentive. The incentive may apply to all goods and services purchased by the customer or only a part thereof. The incentive may include all food. The incentive may exclude all drink. The incentive may include one or more categories of food and/or drink and/or exclude one or more categories of food and/or drink. The incentive may include one or more courses of a meal. The incentive may exclude one or more course of a meal.

The level of the incentive may be entered and/or adjusted by the restaurant operator and/or by the system and/or by the system under the control of one or more parameters and/or limits set by the system and/or restaurant operator. The level of incentive may be higher for expected quieter times and/or days and/or dates. The level of incentive may be higher for times and/or days and/or dates for which the number of bookings is low or lower than a threshold. The level of incentive may be higher for smaller numbers of customers in the booking and/or occasion, for instance lower for two customers than for four customer. The level of incentive may be lower or absent for expected busier times and/or days and/or dates. The level of incentive may be lower or absent for times and/or days and/or dates for which the number of bookings is high or higher than a threshold. The level of incentive may be lower or absent for larger numbers of customers in the booking and/or occasion, for instance lower for six than for four customers.

Any setting of an incentive, consideration of a change to an incentive, change to an incentive or other change can be made in real time.

The booking grid may be provided with data which states whether a time and/or day and/or date is available for booking by a customer. The availability may be conditional on the number of customers indicated for the occasion and/or booking. The data may provide an indication the time and/or day and/or date is not available. The data may indicate why, for instance the slot is full or the restaurant is closed during that slot.

The booking grid may include other data. The other data may include the name of the restaurant and/or the maximum incentive in the time period for the booking grid. The booking grid and/or the page including the booking grid may include one or more means for navigating to other locations in the booking section and/or other sections. These may enable the selection of other time periods and/or dates and/or parts of the day and/or other restaurants.

The system may include one or more other elements of restaurant operator defined content. These elements may include details of the restaurant, the location of the restaurant, pictures, one or more menu pages, price lists.

The customer may be directed to a booking section of the system. The booking section is preferably provided on-line and is preferably provided on the system operator's servers and/or website. The customer may be directed to the booking section from a user's, such as member restaurant operator's, website and/or a search engine and/or the system operator's website.

The customer may be able to search for users, such as restaurant operators matching one or more criteria. The criteria may be or include one or more of restaurant by name, location, food type, price bracket, availability at a day and/or date and/or time or level of incentive offered, special events, such as St Valentine's Day meals.

The booking section may include a directory of restaurant operators. The restaurant operator may be able to edit their own entry, for instance webpage, within the booking section. Each entry within the booking section may follow a common format. The common format may feature one or more elements of common format, such as the layout of the entry and/or the order of information provided and/or the type of information provided and/or a minimum set of information being present. One or more features may be allowed not according to the common format.

The booking section may be accessed through the system operator's website and/or the restaurant operator's website. The booking section may serve as the restaurant operators online booking system or may be supplemental to their own online booking system. The restaurant operators website may include a link to the booking section.

The customer's selection of a restaurant may lead the customer to the booking section for the selected restaurant, particularly a booking grid there for. The customer's selection of a restaurant may lead the customer to a customer number indication section. The selection of the number of customers may lead to the booking section for the selected restaurant, particularly a booking grid there for. The customer may move between different booking grids. The customer may move to a booking grid containing the day or days and/or time or time and/or date or dates of interest. The booking grid may not include any dates earlier than the date on which the customer views the booking grid. The booking grid may include the day's date as the earliest day which is visible to the customer. The customer may be able to scroll or otherwise move through different content for the booking grid. The different days may be accessed by scrolling or otherwise moving to the right from the day's date. The interest may be a target day or date or time prior to viewing the booking grid. The customer may change their interest as a result of seeing the data in the booking grid. The booking grid may provide the customer with information on the availability of one or more times and/or days and/or dates. The booking grid may provide the customer with information on the incentive level available at one or more times and/or days and/or dates and/or numbers of customers. The booking grid may enable a customer to review and/or compare and/or chose between different incentives available at different times and/or days and/or dates and/or numbers of customers.

The booking section may include a section which is pre-filtered using one or more constraints. The one or more constraints may include one or more of: restaurants offering availability within a given, preferably limited, time frame; restaurants offering availability that day; restaurants offering availability in the next 4 hours; restaurants offering availability within a given distance; restaurants offering availability within a given distance of the device used by the customer to make the enquiry; restaurants offering availability within a given distance of a user selected location; restaurants offering an incentive above a threshold level; restaurants offering an incentive and ranked according to the level of the incentive; restaurants of a given type or offering a menu of a given type.

A customer may be able to choose to access a section of the booking section which has been pre-filtered using one or more constraints. The one or more constraints may be provided as defined above. The user may select one or more constraints when making the enquiry and/or one making a further enquiry. The further enquiry may be subject to one or more constraints not in the enquiry.

The customer may access that section by navigating to that section on the website displaying the booking section.

The customer may access that section by using a mobile telecommunications device. The customer may access that section by using a device including a computer. The customer may access that section by using a device operating a piece of application software. The customer may access that section by using a piece of application software on a mobile telecommunications device.

The customer may access that section by making an enquiry and the system providing to the user, preferably on their electronic device, the pre-filtered section.

The customer may make a booking from the options available, for instance using the application software on their device.

The restaurant operator may opt for their restaurant to be included in this section, if they qualify under the constraints, and/or may opt for their restaurant not to be included in this section, even if they qualify under the constraints. The restaurant operator may use the section to, in real time, make incentives available to customers and potential customers. The customer may use the section to, in real time, access the best incentives meeting the one or more constraints.

The enquiry would enable the user to quickly get details of the best offers available at that time, for the near future, in their location. They could then make a selection and then go to the booking which results. The customer can secure the very best deal for their immediate need. The restaurant operator has the ability to attract custom at short notice, for instance due to cancellations or other circumstances, including low demand at that time.

A notification may be provided to a customer of one or more of the following: a time; a day; a date; a incentive level. The notification may be provided to an electronic device of the customer. The electronic device may be a portable device, for instance a mobile phone, PDA, tablet or the like. The notification may be by e-mail, message, SMS or the like. A notification may be provided to a customer who is or has looked at the options under the system for one or more of: that time; that day; that date; that incentive level; that restaurant; that type of restaurant; a restaurant in that geographical area. A customer may be automatically sent such notifications or may opt into receiving the notifications. A notification may only be sent in respect of certain times and/or days and/dates and/or incentive levels. The time and/or day and/or date may be one in the next 12 hours or 24 hours or 36 hours. The notification may result in a change in the customer's plans and generate a booking using the system.

The customer may select a time and/or day and/or date on the booking grid. Preferably a value for each is selected, ideally by making a single selection. The single selection may be made by selecting the slot in a grid which corresponds to the time and day and date selected.

The date may be defined by the particular booking grid and/or booking grid slot selected. The time may be defined by the particular column or row selected. The day may be defined by the particular row or column selected. Preferably one of the day or time is presented in the rows in the grid and the other is presented in the columns.

The date may be defined by the particular booking grid and/or booking grid slot selected. The time may be defined by the particular slot, for instance by stating the value in the slot. The day may be defined by the particular row or column selected. Preferably one of the day is presented in the columns in the grid.

The date may be defined by the particular booking grid and/or booking grid slot selected. The time may be defined by the particular slot, for instance by stating the value in the slot. The day may be defined by the particular slot, for instance by stating the value in the slot.

Preferably a single interaction or selection by the customer defines the day, date, time and restaurant for the booking. Preferably the interaction is provide by a command from the customers computer, for instance by operation of a mouse or key stroke.

The customer may enter the necessary information for the booking through a section of the system. This may be a different section or the booking section. The customer is preferably taken to the section by making the selection of the time, day and date for the booking. The different section may provide for the customer to give the necessary information by means of an indication of their identity. The means of an indication of their identity may be a customer name and/or code, for instance password or pin number or e-mail address. The means of an indication of their identity may be by entering the necessary information. The means of an indication of their identity may be stored for future use or used only on this occasion. The necessary information may be or include the person making the booking, number of people eating and contact details. The contact details may be electronic contact details, such as e-mail or telephone or mobile phone contact details.

The system may provide a report of the booking to the customer. The report may be delivered electronically. The report may provide one or more of the time, day, date, numbers of customers and incentive level for the booking. The report may provide details of the booking and/or cancellation policy applying.

The system may provide one or more reminders of the booking to the customer. The one or more reminders may be sent electronically and/or in an automated manner by the system. The one or more reminders may be sent by a trigger event, for instance a time period to go until the booking.

Various embodiments of the invention will now be described, by way of example only, and with reference to the accompanying drawings in which:

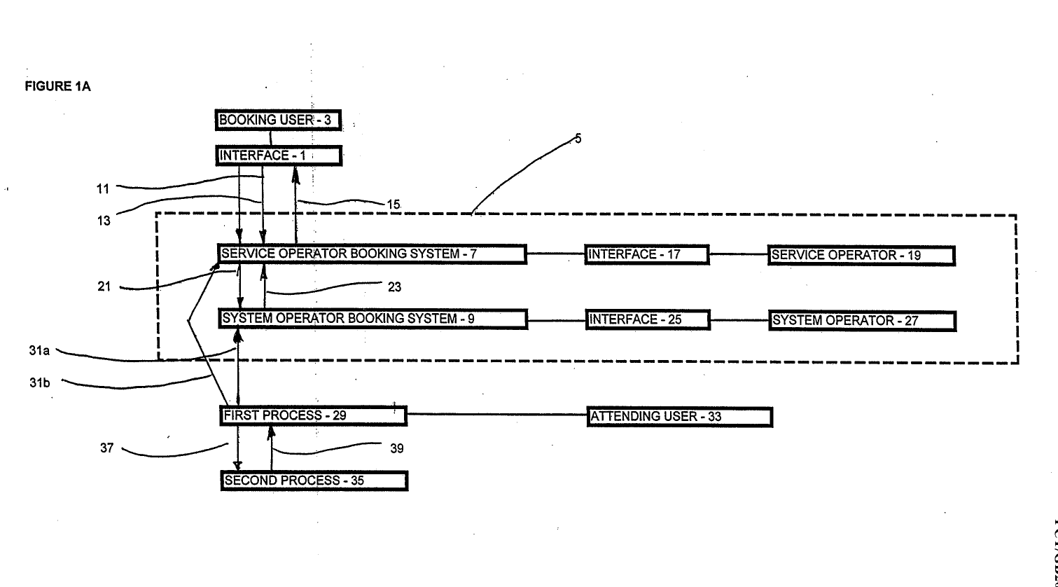

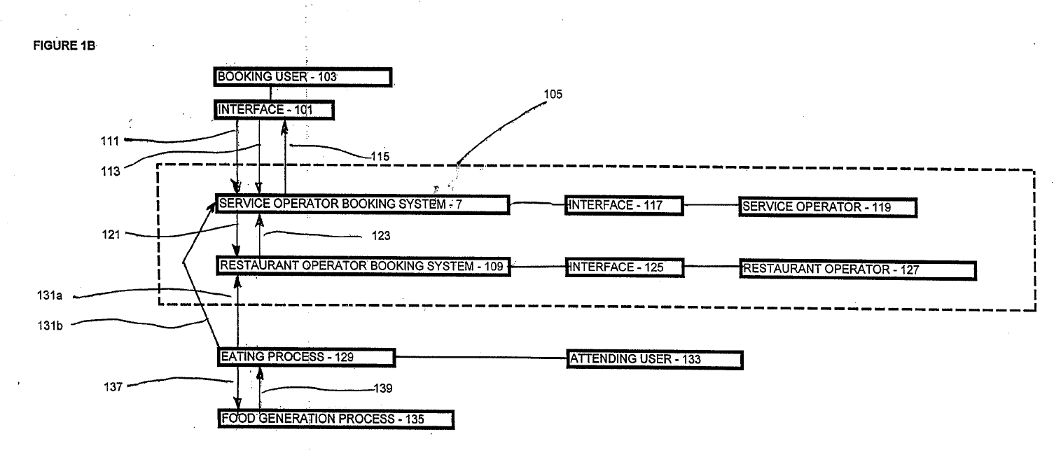

FIG. 1a provides a schematic illustration of the system in a generalised example according to the invention;

FIG. 1b provides a schematic illustration of the system in the context of a restaurant operating system according to the invention;

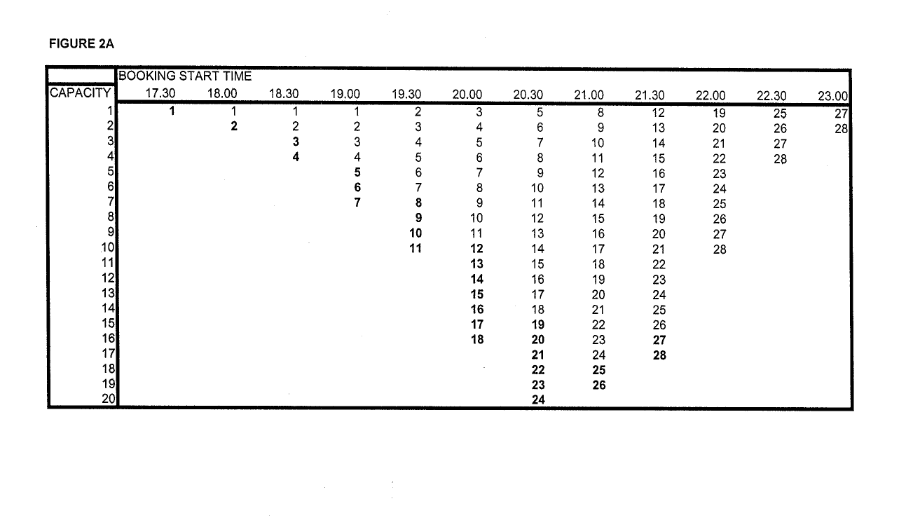

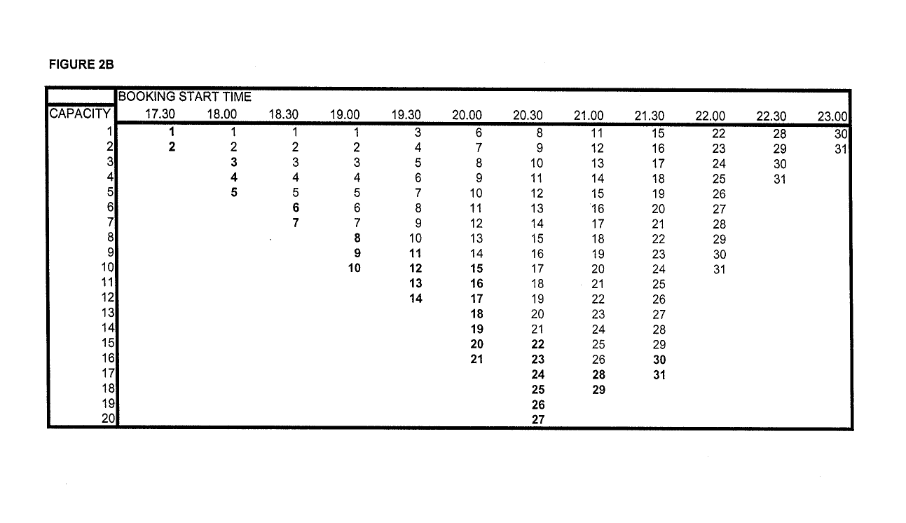

FIG. 2a provides an illustration of the capacity v demand balance without the system of the present invention;

FIG. 2b provides an illustration of capacity v demand with the system of the present invention in use;

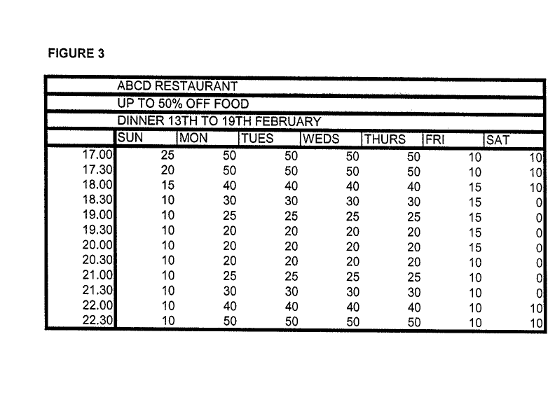

FIG. 3 is an illustration of a first booking page according to an embodiment of the invention;

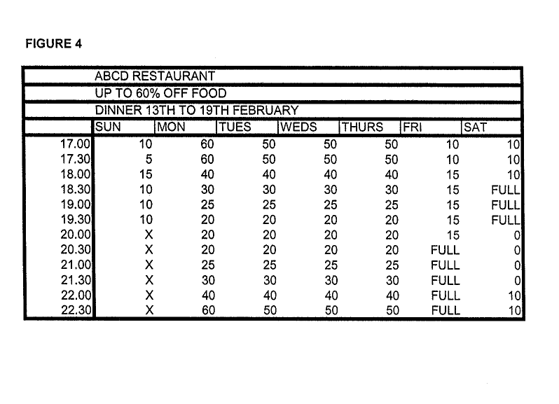

FIG. 4 is the illustration of FIG. 3 updated to reflect changes in bookings;

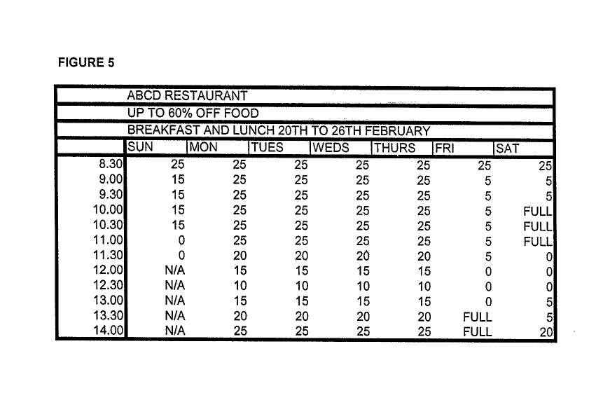

FIG. 5 is an illustration of a further booking page according to an embodiment of the invention;

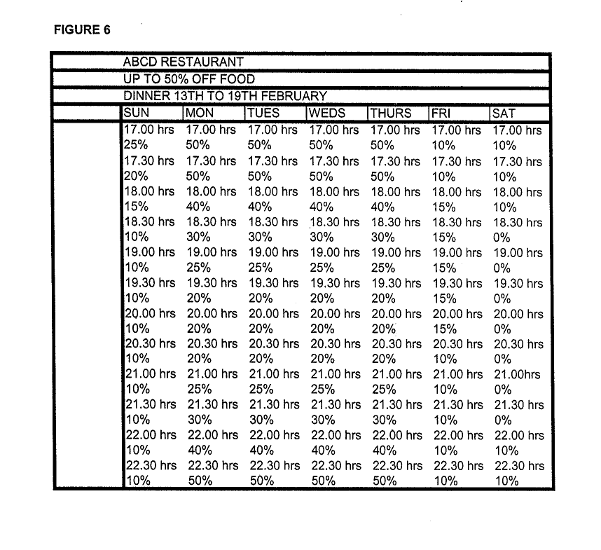

FIG. 6 is an illustration of a further booking page according to a different embodiment of the invention;

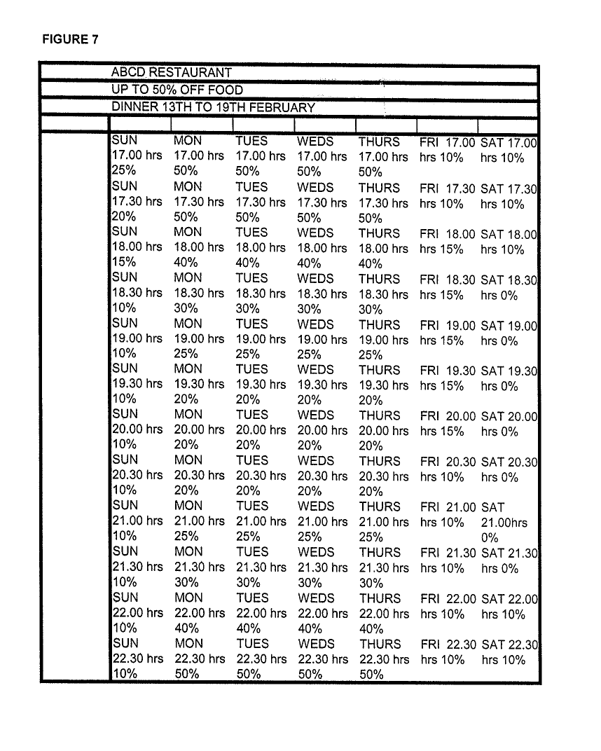

FIG. 7 is an illustration of a still further booking page according to a further embodiment of the invention;

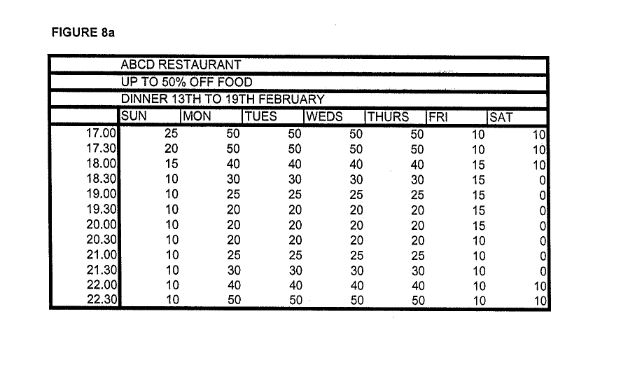

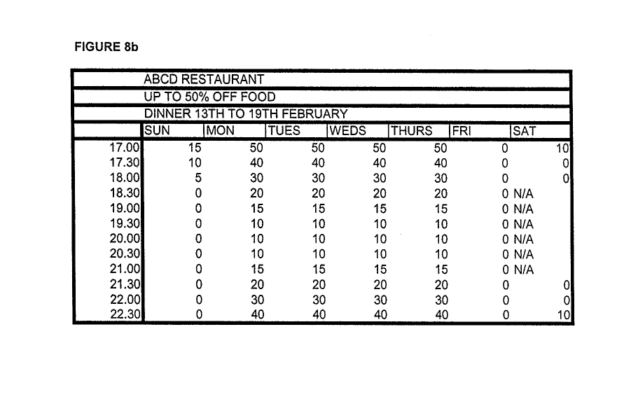

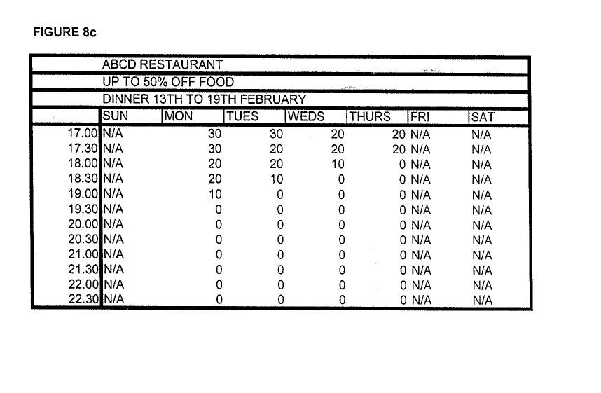

FIG. 8a illustrates the response of the booking page of FIG. 3 to a request from a group of two people;

FIG. 8b illustrates the response of the booking page of FIG. 3 to a request from a group of four people;

FIG. 8c illustrates the response of the booking page of FIG. 3 to a request from a group of ten people;

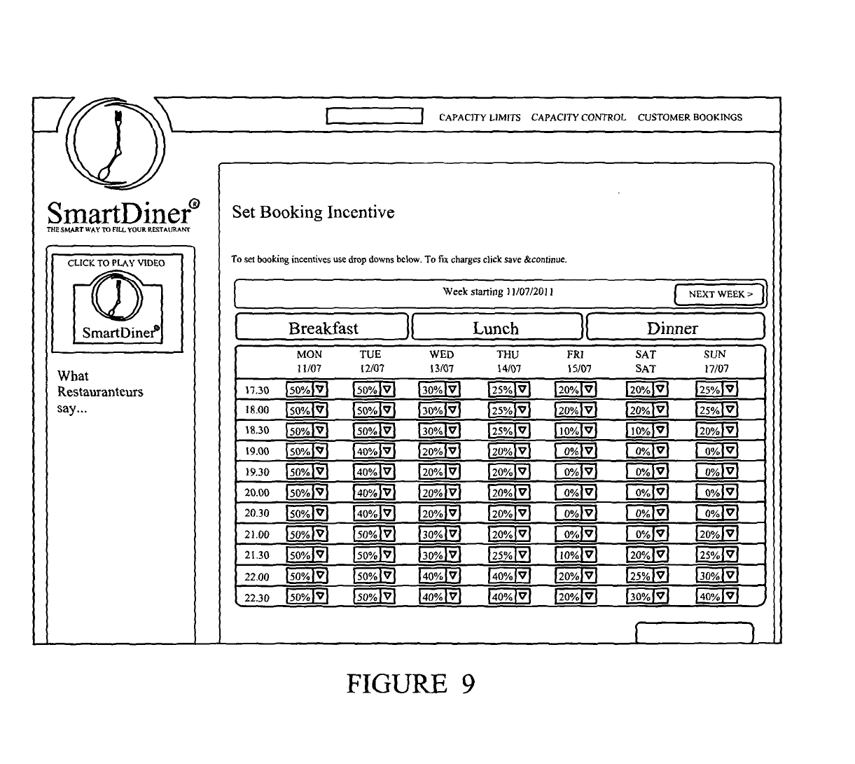

FIG. 9 illustrates a set up screen for a booking grid;

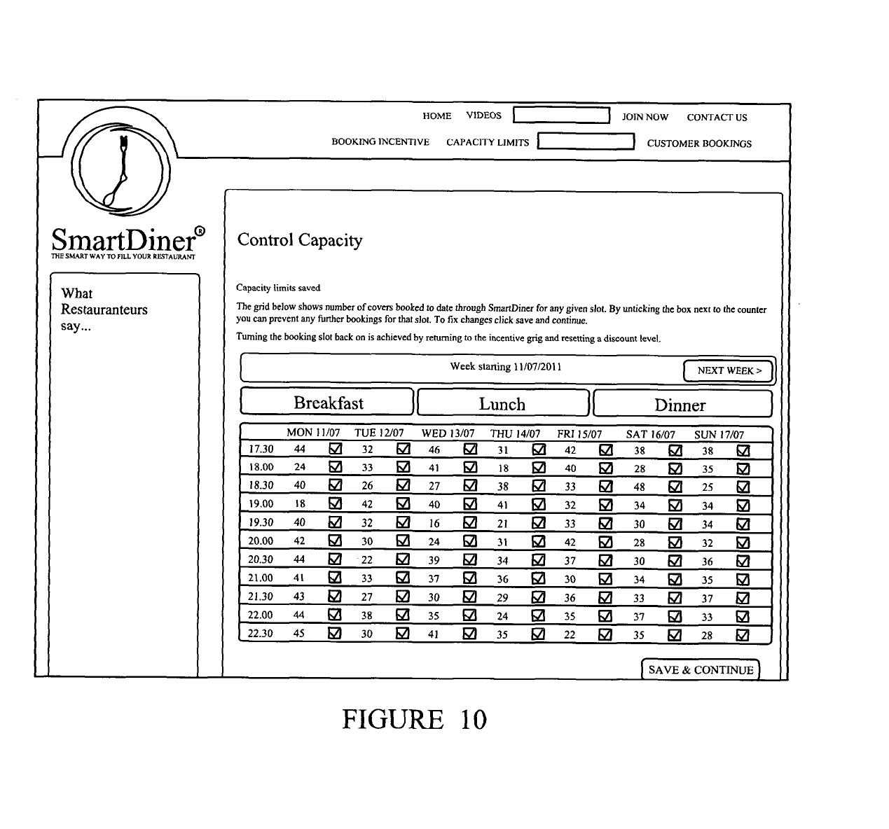

FIG. 10 illustrates a reporting tool provided by one embodiment of the invention;

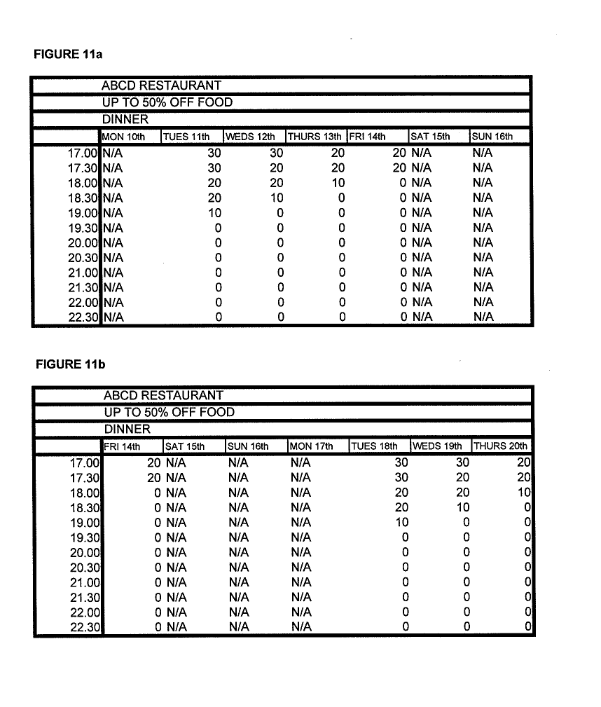

FIGS. 11a and 11b show an alternative form for the booking grid at two different dates.

The invention provides an improved method of operation for a processing system in a wide variety of uses. The uses particularly include those within the restaurant/catering industries.

In one general embodiment, the invention is useful in a system which includes a limited number of processors and/or process locations, with one or more possible processes which can be performed at each processor and/or each process location. Each of the possible processes takes a time period. Hence, the number of processes that the system can handle in a given amount of time is limited. In effect, this defines the capacity of the system. The system will also be presented with a demand for the given amount of time. The demand is formed by the processes and the number of each process which it is desired to perform in the given amount of time. In any system, there may be times when the demand for the given time exceeds capacity and times when the capacity of the system exceeds demand. Conventional systems do little if anything to balance capacity with demand and/or demand with capacity.

The present invention provides the user, system operator, with a mechanism for promoting demand during times where there is over capacity. As a result, the total number of processes performed by the system over a duration is increased; the utilisation is increased. The present invention may also provide the user, system operator, with a mechanism for shifting the timing of demand compared with the system not being applied. The present invention may also provide the user, system operator, with a mechanism for discouraging demand (or generating extra revenue from that demand) during times where there is under capacity or at capacity or limited over capacity. An important feature of the invention is the ability it gives the user, system operator, to react in a tailored way to demand in a real time manner.

The invention is applicable to a wide variety of systems, FIG. 1a, but is exemplified in detail first in the context of a restaurant operating system, FIG. 1b.

In general, the system provides a customer interface 1, through which a booking customer 3 accesses the booking system 5. The booking system 5 includes a service operator booking system 7 in communication with the system operator booking system 9. The customer interface 1 enables the booking customer 3 to make an enquiry 11 of the booking system 5 (such as a look through the options available) and enables the booking customer 3 to make a selection 13 (for instance a time, day and date for a booking). The service operator booking system may receive these and preferably provides a report 15 to the booking customer 3.

The service operator booking system 7 has an interface 17 through which a service operator 19 can interact with the system (for instance its maintenance and updating).

The service operator booking system 7 and system operator booking system 9 are in communication with one another. This allows, for instance, selections 21 to be communicate to the system operator booking system 9 and updates 23 to be communicated to the service operator booking system.

The system operator booking system 9 has an interface 25 through which the system operator 27 can interact with the system (for instance varying the capacity available or other control parameters for the process).

The system further includes the first process 29. The first process 29 can provide capacity information 31a to the system operator booking system 9. The first process 29 may be a process applied to and/or involving the attending customers 33. The attending customer 33 is in effect a booking customer 3 whose booking (time, day, date etc) has arrived.

The system may further include the second process 35. The second process 35 may provide capacity information 31b to the system operator booking system 9. The first process 29 may interact with the second process 35 by providing demands 37 on the second process 35. The second process 35 may interact with the first process 29 by providing responses 39.

The system uses changes in the state of the demand noted by the service operator booking system 7 and/or system operator booking system 9 to vary the content viewed by the booking customer 3. In this way demand can be encouraged and/or discouraged at times, days, dates etc to reflect how demand develops. The result is that the demand on the first process 29 and/or on the second process 35 is better balanced with capacity. This may be through demand approaching or reaching capacity more of the time and/or by avoiding occasions where demand exceeds capacity.

The operation of the system is further explained with reference to the more specific example of FIG. 1b, where a restaurant operating system is provided. As shown in FIG. 1b, the restaurant operating system is formed of similar parts and in a similar arrangement to FIG. 1a. These include a restaurant booking system 105 which is provided so that booking customer 103 can make bookings to use the restaurant of the system operator. As a result of the restaurant booking system 105, attending customers 133 enter the restaurant to be fed.

The system also includes a number of processes. The processes include the eating process 129. The eating process 129 is provided using a finite number of first process locations. The process locations are formed by the eating surface space, seating location and floor space within the bounds of the restaurant. The physical arrangement of those and/or other constraints (such as legal constraints; for instance insurance limits, fire certificate limits or the like) define the finite number of first process locations.

The system also includes the food generation process 135. The food generation process 135 is also provided using a finite number of second process locations and/or second processors. The process locations are formed by the food generation space, including the food preparation space, food cooking space, food serving space, food storage space and the like within the bounds of the restaurant and more commonly within the bounds of the restaurant kitchen. The physical arrangement of those and/or other constraints (such as legal constraints; for instance insurance limits, fire certificate limits or the like) define the finite number of second process locations. Of course, the food generation process 135 is dependent for its capacity of the second process locations and on the number of second process operators available. The second process operators will be cooks, waiters and the like.

The system includes the interface 117, 125 for the service operator 119 and the restaurant operator 127 respectively. In this case, the booking customer interface 101 enables the booking customer 103 to make an enquiry 111 as to which slots are available at the restaurant and what the incentive applying to each slot is. As a consequence, this enables the booking customer 103 to make a selection 113 of the slot they want to book (expressed as a time, day and date for a booking etc). The restaurant operator 127 is notified by communication between the service operator booking system 107 and the restaurant operators booking system 109 as to the booking 121 which has been made. The service operator booking system 107 and/or the restaurant operator booking system 109 may cause the restaurant booking system 105 to be updated as a result to change the slots available and/or the incentive applying.

The first process, the eating process 129 may interact with the second process, the food preparation process 135 by providing demands, orders 137, to the food preparation process 135. The food preparation process 135 may interact with the eating process 129 by providing the responses, food and/or drink 130 to meet the orders 137.

During the operation of the system, the first process 29, 129 and/or the second process 35, 135 each have a capacity. During the operation of the system, the first process 29, 129 and/or the second process 35, 135 each have a demand placed upon them. The result of the operation of the system is that at a series of different times (which may be during a part of a day, for instance an evening; which may be through a whole day, multiple days, weeks or months) the demand is kept at and/or at a level below but closer to capacity for more of the time than if the system were not operating.

The invention provides a restaurant booking system, which allows the restaurant operator to set and vary over time the incentive they wish to offer as applying to different dates, days and times. This allows the restaurant owner to encourage people to use the restaurant in a manner which optimises and/or maximises capacity utilisation and profitability. The restaurant owner has the opportunity to fine tune the system to suit their needs and by being provided in real time it is flexible enough to account for developments as they occur. The incentives can be offered in a targeted and controlled manner, rather than in a blunt and non-specific manner.

The system allows the customer to balance the choice between their preferred time, date and day against the level of incentive they receive for their choice. This is in addition to the normal selection of the restaurant to use for the restaurant services and the time at which to use the restaurant services.

As a result of the restaurant booking system, the behaviour of some customers is modified. Customers may have in mind a time, day, date for a restaurant booking when they go into the restaurant booking system. Such a customer can proceed to make a booking for that pre-selected time, day, date for the restaurant booking. However, some customers may vary from the pre-selected time, day, date based upon the information that the restaurant booking system provides to them because of the incentive that the system provides. As a result, a revised time, day, date is selected for the restaurant booking. The system aims to shift some pre-selected time, day, date combinations which correspond with limited, no further or under capacity to a revised selected time, day, date when there would otherwise be over capacity.

Table 1, also FIG. 2a, provides an illustration of the capacity v demand balance without the system of the present invention and Table 2, also FIG. 2b, provides an illustration of capacity v demand with the system of the present invention in use.

In Table 1 and FIG. 2a, the capacity v demand position for a part of Saturday evening is considered in a simplified manner. The restaurant has 20 places at which customers can be fed. Each customer takes 2 hours from sitting to leaving with respect to their meal. Without any modification of behaviour, a large number of bookings are made for 7 pm, 7.30 pm, 8 pm and 8.30 pm. Fewer bookings are made for 5.30 pm for example. As a result, the restaurant is full to capacity with respect to the first process, the eating process, between 8.30 pm and 9.30 pm, but there is over capacity at other times and the restaurant is near empty at the opening time and the closing time of the restaurant. It is also likely that people who wanted bookings at 8.30 pm but could not may have chosen the same time at another restaurant.

TABLE 1

| | Start Time | | | | | | | | | | | |
|---|---|---|---|---|---|---|---|---|---|---|---|---|
| Capacity | 17.30 | 18.00 | 18.30 | 19.00 | 19.30 | 20.00 | 20.30 | 21.00 | 21.30 | 22.00 | 22.30 | 23.00 |
| 1 | 1 | 1 | 1 | 1 | 2 | 3 | 5 | 8 | 12 | 19 | 25 | 27 |
| 2 | | 2 | 2 | 2 | 3 | 4 | 6 | 9 | 13 | 20 | 26 | 28 |
| 3 | | | 3 | 3 | 4 | 5 | 7 | 10 | 14 | 21 | 27 | |
| 4 | | | 4 | 4 | 5 | 6 | 8 | 11 | 15 | 22 | 28 | |
| 5 | | | | 5 | 6 | 7 | 9 | 12 | 16 | 23 | | |
| 6 | | | | 6 | 7 | 8 | 10 | 13 | 17 | 24 | | |
| 7 | | | | 7 | 8 | 9 | 11 | 14 | 18 | 25 | | |
| 8 | | | | | 9 | 10 | 12 | 15 | 19 | 26 | | |
| 9 | | | | | 10 | 11 | 13 | 16 | 20 | 27 | | |
| 10 | | | | | 11 | 12 | 14 | 17 | 21 | 28 | | |
| 11 | | | | | | 13 | 15 | 18 | 22 | | | |
| 12 | | | | | | 14 | 16 | 19 | 23 | | | |
| 13 | | | | | | 15 | 17 | 20 | 24 | | | |
| 14 | | | | | | 16 | 18 | 21 | 25 | | | |
| 15 | | | | | | 17 | 19 | 22 | 26 | | | |
| 16 | | | | | | 18 | 20 | 23 | 27 | | | |
| 17 | | | | | | | 21 | 24 | 28 | | | |
| 18 | | | | | | | 22 | 25 | | | | |
| 19 | | | | | | | 23 | 26 | | | | |
| 20 | | | | | | | 24 | | | | | |

A similar position applies with respect to the second process, where the start times of the eating process defines when the orders go into the kitchen and when the second processes can start. If this results in the kitchen being over capacity, then the food delivery is slowed, the experience of the customers may become negative and the time taken to complete the first process may be extended and so reduce capacity and/or the ability to deliver a booking on time to following customers.

Testing of the system has shown that the presence of the incentive and the level of the incentive can all have a powerful effect on customer behaviour. For instance, when a small incentive was applied in November, 63 bookings were received, in December no incentive was set because of the high demand then anyway and some 58 bookings were received through the system, however, in January a high incentive generated 102 bookings even though that is generally a quiet month for restaurants. Thus the system has the power to generate additional bookings and move bookings to periods where demand is lower. Similar results have been observed where restaurants have set an initial low incentive for a quiet night, such as a Wednesday, and secured a moderate number of bookings under the system, compared with a very much higher number when they switched to a higher incentive.

In the Table 2 and FIG. 2b illustration, the same restaurant is considered for the same Saturday night, but with the system in operation. As a result, customers see a significant incentive for selecting 5.30 pm as the booking time, rather than 8 pm as the booking time and 21.30 pm compared with 8.30 pm. As a result, some bookings are modified compared with the pre-selected time etc the customer had in mind. More bookings are made for 5.30 pm and 6 pm. These are clear of the restaurant by 7.30 pm, 8 pm and so the same number of people can be accommodated at in the popular slots, 8 pm, 8.30 pm. The spreading of the demand means that there are actually 31 customers served by the same capacity first and second processes compared with the Table 1 or FIG. 2a example. The old high demand times still fill up, as demand exceeded supply, but now the old lower demand slots are in more demand. As a result, the restaurant handles more customers in a session, day, week, month and year. As a result, demand is matched to capacity more of the time. The system operator has the ability to tailor the booking system to give the desired modification in bookings made.

TABLE 2

| | Start Time | | | | | | | | | | | |
|---|---|---|---|---|---|---|---|---|---|---|---|---|
| Capacity | 17.30 | 18.00 | 18.30 | 19.00 | 19.30 | 20.00 | 20.30 | 21.00 | 21.30 | 22.00 | 22.30 | 23.00 |
| 1 | 1 | 1 | 1 | 1 | 3 | 6 | 8 | 11 | 15 | 22 | 28 | 30 |
| 2 | 2 | 2 | 2 | 2 | 4 | 7 | 9 | 12 | 16 | 23 | 29 | 31 |
| 3 | | 3 | 3 | 3 | 5 | 8 | 10 | 13 | 17 | 24 | 30 | |
| 4 | | 4 | 4 | 4 | 6 | 9 | 11 | 14 | 18 | 25 | 31 | |
| 5 | | 5 | 5 | 5 | 7 | 10 | 12 | 15 | 19 | 26 | | |
| 6 | | | 6 | 6 | 8 | 11 | 13 | 16 | 20 | 27 | | |
| 7 | | | 7 | 7 | 9 | 12 | 14 | 17 | 21 | 28 | | |
| 8 | | | | 8 | 10 | 13 | 15 | 18 | 22 | 29 | | |
| 9 | | | | 9 | 11 | 14 | 16 | 19 | 23 | 30 | | |
| 10 | | | | 10 | 12 | 15 | 17 | 20 | 24 | 31 | | |
| 11 | | | | | 13 | 16 | 18 | 21 | 25 | | | |
| 12 | | | | | 14 | 17 | 19 | 22 | 26 | | | |
| 13 | | | | | | 18 | 20 | 23 | 27 | | | |
| 14 | | | | | | 19 | 21 | 24 | 28 | | | |
| 15 | | | | | | 20 | 22 | 25 | 29 | | | |
| 16 | | | | | | 21 | 23 | 26 | 30 | | | |
| 17 | | | | | | | 24 | 27 | 31 | | | |
| 18 | | | | | | | 25 | 28 | | | | |
| 19 | | | | | | | 26 | 29 | | | | |
| 20 | | | | | | | 27 | | | | | |

As discussed below, the system is applicable in a wide variety of situations, but we will continue to use the example of a restaurant to explore the possibilities and setup further.

Different embodiments of the system may be provided which offer different balances between the flexibility and variation possible and the time and skill requirements necessary of the member restaurant operators. The main embodiment described provides a system in which the time and skill requirements made of the restaurant owner are kept low to make the system attractive in its simplicity. Other embodiments which offer more flexibility and variation for the restaurant owner, but as a result requires more training and time to operate, can be provided.

### Special Events

In the majority of cases, restaurants are concerned with operating the booking system on their normal menu in respect of evening sessions, lunch sessions and perhaps breakfast sessions for dining. However, restaurants often want to run special events or promotions and the system can accommodate these too.

For instance, in November and December many restaurants take bookings from larger groups with respect to meals which form part of a Christmas celebration. Certain days, for instance Fridays, are more popular than others for these events. As the date gets nearer to Christmas the popularity also increases.

The present system offers the possibility for a restaurant to use the booking grid or set up a special event booking grid of the same type to handle such bookings. Thus the incentives can be set to encourage bookings in the quieter weeks and on the quieter days. The booking grid covering the event allows for easier promotion of the restaurant as offering such an event. Thus enquires might be made of the general system as to which restaurants are offering Christmas party bookings using the system.

The same general principle applies to various other special events. These may be associated with or be on particular days, for instance Valentine's Day, Burn's Night or the like. They may be particular promotions offered by the restaurant, for instance French food week or the like. Such special events may be accompanied by particular menus for the food and drink available. Indeed it is possible for a booking grid to be set up for a particular menu, even if it is not associated with an event. A grid for a fixed price menu could be provided in this way. This could be provided alongside other grids which deal with normal dining arrangements. In some cases, the incentive used might vary from the % discount often employed to be more specific to the event; for instance an amount of free whiskey to go with a Burn's Night event.

### Special Promotions

The real time ability for a restaurant operator to offer an incentive to encourage use of capacity at quiet times can be used in other ways too. In the situations described in other sections, the incentive is made public and is available to a customer or potential customer using the system over the ensuing time period up until the time the incentive applies too. When they make an enquiry, the incentive is there for them to view and possibly select.

The possibility exists for potential customers to make an enquiry which is filtered for very immediate use. Restaurant operators have the functionality to opt to be included in such very immediate use bookings

The customer could direct their enquiry through a particular part of the website, for instance one which relates to late availability.

The customer could direct their enquiry as a special enquiry, for instance via a computer program, such as through a piece of application software. The application software may be provided on a mobile telecommunications device, such as a telephone.

That enquiry could be for restaurants offering availability within a limited time frame. The time frame could be that day. The time frame could be the next few hours. The enquiry could include or have added to it other constraints. The constraints could be one or more of: a distance from a location, for instance the position of the mobile communications device when the enquiry is made; the level of discount available; the type of restaurant or menu offered; the average meal cost or other ranking criteria.

The enquiry would enable the user to quickly get details of the best offers available at that time, for the near future, in their location. They could then make a selection and then go to the booking which results. The customer can secure the very best deal for their immediate need. The restaurant operator has the ability to attract custom at short notice, for instance due to cancellations or other circumstances, including low demand at that time.

This approach very closely ties together, in real time, the person who is looking for an incentive and those who are offering the incentive.

### Joining the Service Operator's System

The service operator provides the computer software for operating the booking system and organises the necessary hardware for its operation. The service operator also provides a website through which a restaurant operator, who is a potential member restaurant operator, can make an approach to the service operator about becoming a member restaurant operator.

That website is in effect the home website for the service operator. The website could contain testimonials from member restaurant operators about the system, a demonstration of the booking system from the customer's view, a demonstration of the booking system from the member restaurant operator's view, an application form for membership and a summary of the terms and conditions.

When a new restaurant operator decides they want to join the booking system and hence use the restaurant operating system, they make an application through the website. The application will typically include restaurant name, contact details, location(s) and the other information that the service operator needs to set the restaurant operator up on the booking system.

Once the application has been accepted, the member restaurant operator is provided with a customer name and password or pin number to access the booking system. They can then access the booking system, potentially review the terms and conditions and then confirming their acceptance of the membership agreement.

The member restaurant operator, including their IT personnel, then have access to the software which enables them to set up the link to the online booking section of the booking system from their own website, the so called “booking button”. This link is then available from the member restaurant operator's own website and takes customers through to the booking section of the booking system. A customer can then use this to access the service operator's system to make the booking. The member restaurant operator, including their IT personnel, also then have access to the configuration section for the system with respect to their data.

The member restaurant operator can also access training materials, demonstrations on the use of the configuration section for the booking system, and the like.

In the configuration section of the service operator's booking system, the member restaurant operator has the ability to access and configure their data which is considered by the customer when making a booking, the data in the so called “booking grid”. The booking grid has a consistent appearance between member restaurant operators to give the customer familiarity with the approach and operation of the system. The aspects of the content which are editable by the member restaurant operator include the incentive level for a time, day or date and/or the availability of a time, day or date. In effect, this is achieved by setting the value for a slot in the booking grid.

The member restaurant operator will access the configuration part of the booking system at the start of their use and configure the values for the slots in the booking grid. Once this is completed, the entries may be subject to verification and/or review by the service operator before the entries are made accessible to customers.

The booking grid and the values for the slots therein allow the member restaurant operator to achieve a number of advantages. These include optimising capacity utilisation in the restaurant over time, for instance to suit the seating capacity of the restaurant and/or the kitchen capacity of the restaurant. The member restaurant operator is able to exercise far greater control. This includes during a day, between days and between different dates.

As well as the booking grid, the restaurant operator may have other entries in the system. The entry content may vary, but could include: a presentation page detailing the restaurant, its location, introductory message to customers, pictures and the like; and/or one or more menu pages detailing the food available, potentially with prices. The service operator may provide assistance with and/or constraints to the layout and content of one or more of these pages. This information may only be provided by the member restaurant operator's own website.

### Operation

The core of the system is the booking grid. FIG. 3 shows one typical booking grid from amongst those of a member restaurant operator. The booking grid shows the restaurant name, a promotional banner as to the possible incentive level, that it is the evening booking page and that it is the booking page for the week of 13^{th} to 19^{th} February. Navigation buttons elsewhere on the page enable the customer to select different dates and/or the lunch booking page. The booking section is made up of all the booking grids which cover the period for which the member restaurant operator is accepting bookings. This may be member restaurant operator controlled or may be system controlled, for instance a rolling four week period is available.

The member restaurant operator has the ability to put a limit on the slots for which they are willing to accept new bookings within the accessible booking grids. This is done be marking the slots as unavailable. Other terms which further categorise the nature of the unavailability may be provided, for instance full or closed.

When configuring the booking grids with respect to the available slots, the member restaurant operator is able to specify the presence or absence of an incentive for that slot. Generally this will be expressed as a percentage incentive. That may be a percentage of all goods and services. It may be expressed as a percentage of the food only, thereby excluding drinks from the incentive, for instance.

As well as the presence or absence of an incentive for a slot, the member restaurant operator is also able to specify the level of the incentive Thus, no incentive may be offered for Saturday evening, other than the very early or late slots, because most of Saturday evening is busy normally. Friday and Sunday's may be provided with incentives, but with mid week days having the highest incentives.

In FIG. 4, the real time ability of the booking grid to adjust is shown. In this case, a significant number of bookings have been received at various times during the week. This has resulted in the later part of Friday and mid part of Saturday having slots deemed fully booked and hence not available for further bookings A reasonable number of bookings have also been received for early Sunday evening slots and so the level of incentive offered is reduced, 25% and 20% reduced to 10% and 5%. However, the lower level of bookings than expected for Monday evening slots has lead to a higher level of incentive being offered, up from 50% to 60%. The header on the booking grid updates to reflect the new higher incentive available.

The service operator and in particular the computer software offers to the member restaurant operator includes a variety of tools and/or templates to enable them to relate the incentive offered in the slots to their normal booking level for a given slot, based upon its time, day, month or date. This potentially includes the ability to respond as the bookings develop and the time or day or date in question approaches.

### Customer Access

The customer can access the service operator's booking system to make the booking from the member restaurant operator's own website. The customer can also access the service operator's booking system directly and so access member restaurant operator's in that way. Only members are on the service operators booking system.

When accessing via the service operator's booking system, a customer can chose a restaurant by name, location, food type. The choice could even be made based upon availability at a date and/or time or level of incentive offered.

The selection takes the customer to the booking section for the selected restaurant. The customer can then navigate to the booking grid which has the time and dates of interest for that selected restaurant. In FIG. 5, the customer has selected the morning and lunch booking page for 20^{th} to 26^{th} February. The customer may have thought about selecting a lunchtime slot on Friday. They see that these are available, but note that the same time slot on Thursday carries a 15% incentive. As a consequence, the change their mind and make the booking for a slot on Thursday at 12.30 instead. The customer is happy because they have got an incentive and the restaurant owner is happy because they have balanced out their level of custom and encouraged use at a quieter time or at a time which gives a more even load on the kitchen.

Having chose the slot, the customer clicks on that slot to make the booking A key benefit of the system is that a customer can compare time, day, date and incentive for an extensive period of time by reviewing the booking grid. The customer can readily see all the options. The customer has the convenience of seeing all the options at once.

Furthermore, the customer can make the selection of time, day, date and incentive in a single click on that slot on the booking grid. All of the selections are made at once. There is no need to make the selection in a series of steps, for instance chose the date, chose the evening, chose the time, see the incentive. All the information is immediately there and can be selected.

Clicking on a slot takes the customer to a follow up page to complete the booking. This offers them the choice of booking using an existing account they have already set up on the system (for convenience and speed of booking), the ability to create a new account for use now and in the future (for future convenience) or the ability to make a one off entry of the necessary information. This follow up page captures the necessary information. This may be or include the person making the booking, number of people eating and contact details. E-mail or mobile phone contact details are preferred so that the system can send a confirmation report direct to the person electronically. The confirmation could detail the time, day, date, incentive and potentially details of the booking and cancellation policy applying. Reminders may also be sent in this way as the time or day or date is approached. Other possible formats for the booking grid can be used. In FIG. 6, the same information is provided as is provided in FIG. 3, 4 or 5, but more of the information has been shifted into the individual slots. Thus, the time information has moved from being a column which presented the label for each row to be explicitly stated in each slot. In FIG. 7, this approach is taken further and all of the time, day and incentive information is presented in the slots. The row which provided the label for each column is removed.

Because the booking system provides such an easy and adjustable way for setting incentives it offers other possibilities beyond matching capacity and demand. Restaurants generally have a menu and a price for that menu. The price is intended to represent value to the customer at all times of the day, week, month etc. However, the demand for the popular slots exceeding the capacity suggests that these are more valuable than the price being charged. Using the system of the invention it is possible to set a higher menu or normal price than before, because it can be readily incentivised in a tailored manner. Hence the prices are competitive and encourage demand at all times, whilst maximising the price for the traditionally busy times; a slot at 8 pm on Saturday is worth more than a slot at 6 pm on Monday, for instance.

### Further Functionality

In the approaches described above, the discount could be a function of the date, day or time for which a slot is selected. This allowed the system to balance demand with capacity to a greater degree. In this further functionality, the system is also able to offer further balance between demand and capacity.

Observation of groups of diners shows that on average the larger the group the longer they take from start to finish with their activity.

In the case of dining, two diners may well go from start to finish in the restaurant in 1.5 hours. A group of four may take 2 hours and a group of six take 2.5 hours. If this information is combined with a consideration of the spend by those groups, then significantly less profit is made from larger groups over time than from smaller groups.

The position can be expressed as shown in Table 3.

| | | | Profit per | |
|---|---|---|---|---|
| | | | Customer per | |
| No. Of | Dining | Undiscounted | Hour (65% | Reduction in |
| Customers | Duration | Meal Cost | margin) | Profit |
| 2 | 1.5 hours | £25 per | £10.83 per | 0% |
| | | customer | customer | |
| 4 | 2.0 hours | £25 per | £8.13 per | 25% |
| | | customer | customer | |
| 6 | 2.5 hours | £25 per | £6.50 per | 40% |
| | | customer | customer | |

It takes longer to process a larger group through the restaurant than the same number of people in a number of smaller groups. This can be expressed in terms of the revenue per available seat per hour for the restaurant. A group of four might give a value of £12.50 whereas a group of two might give a value of £16.00 revenue per available seat per hour.

Taking this position into account, the present invention allows a user to set the discount accordingly. When a customer accesses the system, they are first asked to provide an indication of the number of customers who will be attending. The customer then goes on to select the occasion of interest to them and hence they reach the booking grid including that occasion. The system populates the booking grid with discounts as before, but in this case they also factor in the number of customers. A lower discount is offered for larger groups than if a smaller group is involved. The system may even be formatted so as not to allow a discount or even allow the booking for a larger group.

This last principle is illustrated with reference to FIGS. 8a, 8b and 8c. The booking grid in these cases is of the same type; the type discussed above in relation to FIG. 3.

In FIG. 8a, the booking grid is displayed in response to an enquiry from a group of two people. A group of two spends less time in the restaurant for the amount they spend and is easier to accommodate within the capacity for a restaurant. As a consequence, they are an attractive booking to the restaurant at all times and the full range of discounts offered is available. These are highest for the quieter times and the quieter days (early evening and early in the week). These are lower, but still present for busier times (Friday and Sunday). At the busiest times (Saturday), a booking can be made, but without any discount as an incentive.

In FIG. 8b, the booking grid is shown for the same underlying data (restaurant, dates and number of bookings so far), but the group making the enquiry is a group of four. As a result, the booking grid is materially different. At the quieter times, the incentives are still available as the restaurant is keen to take any bookings then (early most evenings and early in the week). However, the restaurant does not need to encourage such bookings on busier days (Friday and Sunday) and so the incentives are not present. For the busiest time of the week, the restaurant operator has elected not to accept bookings at all thorough this booking system. Instead, they intend to rely upon bookings through more conventional routes and at no discount being sufficient to fill them.

In FIG. 8c, a more extreme example is shown. Again, everything is the same apart from the number in the group and the impact that has upon the incentives offered and availability of bookings through this system. In this case, the group is ten people and so the restaurant only wants to encourage them on certain days and at certain times. At peak times, the restaurant would be able to process twenty or more people as couples using the same amount of time and the sample places. Hence the group of ten is not such a profitable proposition. As a result, they are still offered the full incentive at certain quieter times and days, a lower incentive at certain times and days, no incentive at moderate times and days. On the busier days (Friday, Saturday and Sunday) there is no availability offered. Additionally, the restaurant operator may not offer any incentive for later starting times for such a large group with respect to the later slots, even on quiet days, due to the late hour at which they would finish compared with other diners and/or normal operating hours for the restaurant.

In some cases, the restaurant owner may want to only make the system available for larger groups to make bookings. This may be because of the nature of the restaurant, the number of places at the individual tables or for other reasons. As a consequence, the system is provided with the ability for the restaurant owner to set a group size below which a booking cannot be made at any time, day or date. Selections within this blanket exclusion may be used, for instance to require such a minimum group size at busy times, but not at quieter times; on busy dates, but not on quieter dates etc.

### Alternative Booking Grid Formats

As shown in FIGS. 9 and 10, the booking grid can be provided with a week displayed, with the next week on a further page and so on. This has the disadvantage that as the current week progresses that less and less of the days on the first page are in the future and more and more are in the past (and so not available). Improved functionality can be achieved by the booking grid format shown in FIGS. 11a and 1b.

In this format, the day corresponding to the present date is always the first column (or in the alternative alignment first row). In the case of FIG. 11a, the position is shown when the date is 10 February, and so it shows Monday 10^{th} February as the first column, with Tuesday 11^{th} February to its right and then Wednesday 12^{th} February to the right of that. The user can scroll as far as they want to bring up future dates from the right. As the scrolling progresses, only 7 days are shown and so the dates scroll off the left of the screen. The time slots for each date are provided in the rows progressing down the booking grid.

By the time the day's date has become Friday 14^{th} February, then the booking grid has automatically scrolled with it. It is no longer possible to see Thursday 13^{th} or the days before that. This position is shown in FIG. 11b.

### Alternative Promotion Routes

As mentioned elsewhere, the approach allows for rapid and real-time updating of the booking grid to encourage changes in booking behaviour. In this option, it is possible for the method to encourage such changes even very close to the time slots in question being reached.

In an example, the restaurant operator has a number of time slots on that days date which are not booked. As a consequence, they would like to encourage people to book them rather than let the slots pass empty. Using the system they can update the discount given to the time slots, by discounting it more heavily, to encourage anyone browsing to select one of those time slots. Given the short time period left, this may be an aggressive discount level to attract attention. In addition, the system could include this discount into a notification to users looking for, or even who have looked for, a restaurant at one or more of the times involved. The notification could be sent to the user by various means, including a message to an electronic device of theirs, for instance a text message to their mobile phone. This alerts the user promptly to the discount and could lead to them making a last minute booking because of the discount. The restaurant operator may chose to have such last minute discounts included in the notification system or they may automatically do so. A user is thus given the most up to date information and may eat at a significant discount as a result. The restaurant operator is given the maximum chance of securing extra bookings for a restaurant where the capacity is already in place waiting to be used.

### Benefits

The invention provides a number of benefits to the user, such as restaurant operator. These include the ability to:

a) Encourage greater and optimised use of the restaurant services through the offer of incentives.

b) Organise the use of their restaurant services into date and/or time slots and to customise the presence of an incentive and/or level of an incentive with respect to those date and/or time slots. This can be used to encourage use of the restaurant services on quieter days and/or at quieter times and so increase the amount of time for which the restaurant services are in use and/or provide a better balance of load on the kitchen. Lower incentives or no incentives could be offered during busy day slots and/or time slots. FIG. 9 shows a typical booking grid, broken into time slots and dates and with pull down menus which can easily be used by the restaurant operator to set the incentive. The selections are saved using the button, bottom right.

c) Control the number of customers accessing the restaurant during one or more slots by making them available or not. As shown in FIG. 10, it is possible for a restaurant owner to view the number of bookings made through the system to that point in time. The restaurant owner can readily see the number of bookings made for each slot on each date. As a consequence, they can change the incentives set up for the various slots or remove the possibility of booking that slot by removing the ticking against the slot. As shown in FIG. 10, the different tabs or buttons provided for breakfast, lunch and dinner allow the restaurant operator to move between the different parts of the day. A similar approach applies on the booking grid for the user of the system.

d) Vary in realtime the incentives offered for slots to spread bookings for the restaurant services effectively.

e) Offer simple online booking of restaurant services 24 hours a day, without the cost of support staff.

f) Gain business from being linked to the service operator's system and/or other online booking websites.

g) Have a competitive advantage compared with restaurant operators outside of the service operator's system.

h) Gain significant advertising and custom from association with the service operator's system.

I) Make mail shots and/or e-mail shots through the service operator's system to potential and past customers to generate further business.

j) Offer incentives to specific customer types, for instance families or senior citizens, to use the services at particular time slots and/or day slots.

The restaurant operator gains these advantages for a relatively low charge made by the system operator. The charge is only made when a booking is made and so the charge only applies when the restaurant owner has gained a far larger transaction in their favour. The restaurant operator gains not only a method for capacity optimisation, but also a method which provides for improved restaurant revenue management.

As well as controlling the position in advance of a point in time being reached, the system also allows the restaurant operator to review the usefulness of the system to them and/or the extend of use of the system to date. By reviewing a screen like that shown in FIG. 10 after the time has passed, the restaurant owner can view the grid for a week and observe for each slot on each day, the number of bookings made through the system. This can provide statistics for the restaurant owner to truly establish the busier and quieter times and guide future incentive setting.

The advantages to the customer include the ability to:

a) Make a booking online simply.

b) Choose a restaurant easily from those available, including the ability to select from a list of the customer's favourites and/or indexed by food type, location or other characteristics.

c) Choose the restaurant and/or day slot and/or time slot based on convenience, the level of incentive offered.

d) Obtain easy confirmation of the booking

e) The ability for the customer to quickly and easily comprehend and compare the incentive/discount offered; in contrast with approaches based upon multiple and often bewildering offers provided through other routes.

The advantages to the service operator include:

a) Generating revenue through a signup fee for a restaurant operator joining the system;

b) Generating a small fee, paid by the restaurant owner to the service operator, for each for booking made using the system.

1. A method comprising:
providing one or more process locations for performing an operation, the operation comprising one or more processes, the operation having a capacity, the one or more processes being performed at one or more process locations, the one or more process locations having respective capacities;
providing a user interface, the user interface configured to receive one or more indications of demand for a portion of respective capacities of the process locations;
receiving one or more of the indications of demand;
considering the received indications of demand; and
making one or more adjustments to the user interface, the one or more adjustments promoting one or more further indications of demand for a further portion of the respective capacities of the process locations.

2. The method of claim 1,
wherein a number of the one or more process locations is limited, and wherein the one or more process locations can perform one or more of the processes, respective processes taking a time period to perform, the capacity for the operation is determined, and respective capacities for the process locations are established.
respective indications of demand including a required time, the one or more indications of demand being received in advance of the respective required times, the considering the one or more indications of demand further comprises considering respective required operation times against a process location capacity, the considering occurring
in advance of the respective required times, and wherein making one or more adjustments comprises adjusting the respective required times in response to the one or more indications of demand being below a level,
the level being defined relative to the capacity for a process location, the adjustment being made in advance of respective required times, the method further comprising
receiving one or more further indications of demand for a further portion of a capacity of a process location, the further indications comprising a required time, the further indications being received in response to an available capacity at the required time.

3. The method of claim 1, wherein the user interface is used by a customer and the operation is operated by a restaurant operator.

4. The method of claim 1, wherein the one or more adjustments comprise one of a provision of an incentive and a change to an incentive.

5. The method of claim 4, wherein the incentive is a percentage discount.

6. The method of claim 1, wherein the method is computer implemented.

7. The method of claim 1, wherein the operation is a catering operation and wherein the one or more processes comprise one of:
the occupation of a seat by a customer of the operation;
the consumption of food and/or drink; and
a food generation process.

8. The method of claim 1, wherein the one or more process locations comprise:
eating surface spaces;
seating locations;
floor space within the bounds of the operation;
food generation spaces; and
vehicles delivering to a customer.

9. The method of claim 1, wherein the user interface is operated via an electronic device and the indications of demand are provided through a telecommunications network.

10. The method of claim 1, wherein the user interface enables the customer to access a booking grid.

11. The method of claim 10, wherein the booking grid includes a row or column for each day in a time period and the booking grid includes a column or row for each different time slot in a further time period.

12. The method of claim 10, wherein the booking grid provides the customer with one of:
information on the availability of one or more times;
information on the incentive level available at one or more times;
information on the incentive level available based on a number of customers;
the ability to review an availability of different incentives.

13. The method of claim 3, wherein the restaurant operator sets an incentive to be available at one or more of:
different dates;
different days;
different times;
a number of customers in a booking.

14. The method of claim 3, wherein the restaurant operator periodically varies the incentive based on a number of bookings received for required times.

15. The method of claim 1, wherein making of one or more adjustments is done in real time.

16. The method of claim 1, wherein the one or more adjustments provide one of an in increased incentive and a decreased price, the one or more adjustments to promote a customer considering making an indication of demand after the adjustment to select a different required time from their intended required time.

17. The method of claim 1, the method further comprising operating one or more of the process locations to respond to one or more demands, and making one or more adjustments to change a distribution of the one or more indications of demand.

18. The method of claim 1, the method further comprising distributing the indications of demand based on an availability at one or more process locations.

19. The method of claim 1, the method further comprising promoting a
demand during required times where there is excess capacity, and increasing a
total number of processes performed by the operation over a duration of time.

20. A booking system comprising:
a computer;
a set of data, the set of data including one or more occasions for which a booking can be made, one or more of said occasions having an associated incentive, the incentive being a change in price at an occasion; and
one or more remote access routes through which one or more other computers can communicate with the computer.

21. A method of making a booking comprising:
accessing a booking system;
viewing at least a part of a set of data held by the booking system, the set of data including one or more occasions for which a booking can be made, one or more of said occasions having an associated incentive; and
selecting an occasion from the one or more occasions for a booking.
